(19) United States
(12) Patent Application Publication
(10) Pub. No.: US 2021/0221219 A1
(43) Pub. Date: Jul. 22, 2021

(54) VEHICLE

(71) Applicant: TOYOTA JIDOSHA KABUSHIKI KAISHA, Aichi-ken (JP)

(72) Inventors: Toshio WATANABE, Toyota-shi (JP); Keisuke SHIBATA, Miyoshi-shi (JP); Masao WATANABE, Okazaki-shi (JP); Kenta MIYAHARA, Toyota-shi (JP)

(21) Appl. No.: 17/037,489

(22) Filed: Sep. 29, 2020

(30) Foreign Application Priority Data
Jan. 22, 2020 (JP) 2020-008761

(51) Int. Cl. B60K 11/08; B60K 11/04; B60K 1/04

(52) U.S. Cl. CPC B60K 11/085; B60K 11/04; B60K 2001/005; B60K 2001/0405; B60K 1/04

(57) ABSTRACT

Provided is a vehicle including: a vehicle main body capable of traveling in both directions along a vehicle front-rear direction; a first radiator that is provided at an end of the vehicle main body on one side in the vehicle front-rear direction and performs heat exchange with an object-to-be-cooled provided in the vehicle main body through a refrigerant; and a second radiator that is provided at an end of the vehicle main body on the other side in the vehicle front-rear direction and performs heat exchange with the object-to-be-cooled through a refrigerant.

### CROSS-REFERENCE TO RELATED APPLICATION

This application claims priority to Japanese Patent Application No. 2020-008761 filed on Jan. 22, 2020, incorporated herein by reference in its entirety.

### BACKGROUND

### 1. Technical Field

The disclosure relates to a vehicle.

### 2. Description of Related Art

Japanese Patent Application Publication No. 2019-189010 (JP 2019-189010 A) discloses a structure in which a radiator is provided at a front end of a vehicle.

### SUMMARY

A vehicle that is capable of traveling in both directions along a vehicle front-rear direction and therefore need not make U-turns is under consideration. However, if the vehicle disclosed in JP 2019-189010 A is adapted to travel in both directions along a vehicle front-rear direction, heat exchange is performed in the radiator only when the vehicle travels in one direction, which leaves room for improvement from the viewpoint of effectively cooling an object-to-be-cooled.

In view of this fact, the disclosure aims to obtain a vehicle that is structured to be able to travel in both directions along a vehicle front-rear direction and can effectively cool an object-to-be-cooled regardless of the traveling direction.

A vehicle according to claim 1 includes: a vehicle main body capable of traveling in both directions along a vehicle front-rear direction; a first radiator that is provided at an end of the vehicle main body on one side in the vehicle front-rear direction and performs heat exchange with an object-to-be-cooled provided in the vehicle main body through a refrigerant; and a second radiator that is provided at an end of the vehicle main body on the other side in the vehicle front-rear direction and performs heat exchange with the object-to-be-cooled through a refrigerant.

In the vehicle according to claim 1, the vehicle main body is configured to be able to travel in both directions along the vehicle front-rear direction. The first radiator is provided at the end of the vehicle main body on the one side in the vehicle front-rear direction, and this first radiator performs heat exchange with the object-to-be-cooled provided in the vehicle main body through the refrigerant. Thus, when the vehicle main body travels in one direction, heat exchange is performed between traveling air introduced into the first radiator and the refrigerant, so that the object-to-be-cooled can be cooled with the cooled refrigerant.

On the other hand, when the vehicle main body travels in the other direction, heat exchange is performed between traveling air introduced into the second radiator and a refrigerant, so that the object-to-be-cooled can be cooled with the cooled refrigerant. In this way, the object-to-be-cooled can be effectively cooled in whichever direction the vehicle travels.

A vehicle according to claim 2 is the vehicle according to claim 1 and further includes: a first shutter capable of opening and closing an opening through which traveling air is introduced into the first radiator; a second shutter capable of opening and closing an opening through which traveling air is introduced into the second radiator; and a controller that opens and closes the first shutter and the second shutter in such a manner that the first shutter is opened and the second shutter is closed when the vehicle main body travels toward one side in the vehicle front-rear direction and that the first shutter is closed and the second shutter is opened when the vehicle main body travels toward the other side in the vehicle front-rear direction.

When the vehicle main body of the vehicle according to claim 2 travels toward the one side in the vehicle front-rear direction, the controller opens the first shutter and traveling air is thereby introduced into the first radiator. Meanwhile, the controller closes the second shutter, so that an air current having flowed toward the other side in the vehicle front-rear direction along an outer surface of the vehicle main body during travel of the vehicle can be kept from entering the second radiator.

On the other hand, when the vehicle main body travels toward the other side in the vehicle front-rear direction, the controller opens the second shutter and traveling air is thereby introduced into the second radiator. Meanwhile, the controller closes the first shutter, so that an air current having flowed toward the one side in the vehicle front-rear direction along the outer surface of the vehicle main body during travel of the vehicle can be kept from entering the first radiator.

A vehicle according to claim 3 is the vehicle according to claim 1 and further includes: a first fan that is activated to introduce outside air into the first radiator; a second fan that is activated to introduce outside air into the second radiator; and a controller that activates the second fan when the vehicle main body travels toward one side in the vehicle front-rear direction, and activates the first fan when the vehicle main body travels toward the other side in the vehicle front-rear direction.

In the vehicle according to claim 3, the controller activates the second fan when the vehicle main body travels toward the one side in the vehicle front-rear direction. Thus, outside air is introduced into the second radiator and heat exchange is performed in the second radiator. On the other hand, when the vehicle main body travels toward the other side in the vehicle front-rear direction, the controller activates the first fan. Thus, outside air is introduced into the first radiator and heat exchange is performed in the first radiator. In this way, heat exchange can be performed in both the first radiator and the second radiator in whichever direction the vehicle main body travels.

A vehicle according to claim 4 is the vehicle according to claim 1 and further includes: a first fan that is activated to exhaust air from the first radiator toward one side in the vehicle front-rear direction; a second fan that is activated to exhaust air from the second radiator toward the other side in the vehicle front-rear direction; and a controller that activates the second fan when the vehicle main body travels toward the one side in the vehicle front-rear direction, and activates the first fan when the vehicle main body travels toward the other side in the vehicle front-rear direction.

In the vehicle according to claim 4, when the vehicle main body travels toward the one side in the vehicle front-rear direction, the controller activates the second fan and air is thereby exhausted from the second radiator toward the other side in the vehicle front-rear direction. Thus, an air current having flowed toward the other side in the vehicle front-rear direction along the outer surface of the vehicle main body is regulated, and outside air can be kept from entering the second radiator.

On the other hand, when the vehicle main body travels toward the other side in the vehicle front-rear direction, the controller activates the first fan and air is thereby exhausted from the first radiator toward the one side in the vehicle front-rear direction. Thus, an air current having flowed toward the one side in the vehicle front-rear direction along the outer surface of the vehicle main body is regulated, and outside air can be kept from entering the first radiator.

A vehicle according to claim 5 is the vehicle according to any one of claims 1 to 4, wherein the object-to-be-cooled may include a driving battery that is provided at a central part of the vehicle main body in the vehicle front-rear direction.

In the vehicle according to claim 5, the driving battery can be cooled to keep the temperature of the driving battery from rising. Since the driving battery is provided at the central part of the vehicle main body in the vehicle front-rear direction, the distance from the first radiator to the driving battery and the distance from the second radiator to the driving battery are approximately equal. Therefore, the length of a refrigerant flow passage on the first radiator side and the length of a refrigerant flow passage on the second radiator side are approximately equal, which can reduce changes in the cooling performance according to the traveling direction of the vehicle main body.

As described above, the vehicle according to claim 1 is structured to be able to travel in both directions along the vehicle front-rear direction and can effectively cool the object-to-be-cooled regardless of the traveling direction.

The vehicle according to claim 2 can deliver enhanced aerodynamic performance while traveling.

The vehicle according to claim 3 can deliver enhanced cooling performance.

The vehicle according to claim 4 can deliver enhanced aerodynamic performance despite the configuration thereof not including a shutter.

The vehicle according to claim 5 varies less in the cooling performance

### BRIEF DESCRIPTION OF THE DRAWINGS

Features, advantages, and technical and industrial significance of exemplary embodiments of the disclosure will be described below with reference to the accompanying drawings, in which like numerals denote like elements, and wherein:

FIG. 1 is a schematic side view showing main parts of a vehicle according to a first embodiment;

FIG. 2 is a schematic side view showing main parts of the vehicle according to the first embodiment, in a state where a first shutter is open and a second shutter is closed;

FIG. 3 is a schematic side view showing main parts of the vehicle according to the first embodiment, in a state where the first shutter is closed and the second shutter is open;

FIG. 4 is a schematic side view showing main parts of a vehicle according to a second embodiment; and

FIG. 5 is a schematic side view showing main parts of a vehicle according to a third embodiment.

### DETAILED DESCRIPTION OF EMBODIMENTS

### First Embodiment

A vehicle 10 according to a first embodiment will be described with reference to the drawings. Unless otherwise noted, directions used in the following description that are referred to simply as frontward, rearward, upward, downward, leftward, and rightward mean frontward and rearward in a vehicle front-rear direction, upward and downward in a vehicle up-down direction, and leftward and rightward as seen from a vehicle frontward direction, respectively.

The vehicle 10 of the embodiment is an electric vehicle capable of traveling in both directions along the vehicle front-rear direction. Therefore, no distinction will be made between the frontward direction and the rearward direction, but for the convenience of description, one side and the other side in the vehicle front-rear direction will be referred to as a front aide and a rear side, respectively. Arrows FR and UP shown as necessary in the drawings indicate the front side and the upper side, respectively, of the vehicle 10.

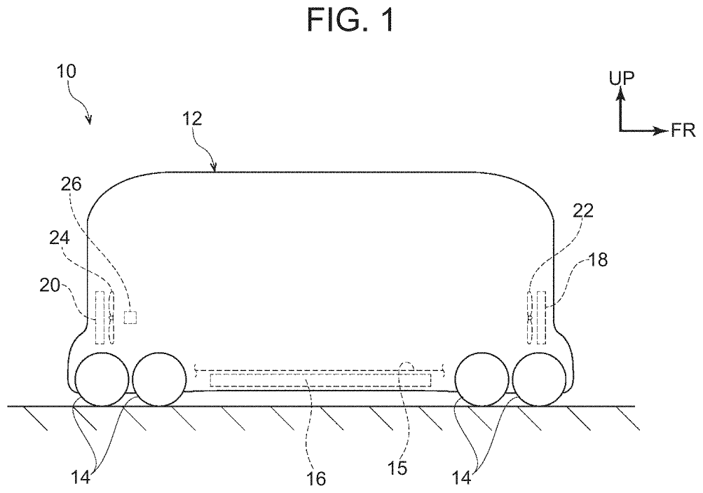

As shown in FIG. 1, the vehicle 10 of the embodiment includes a vehicle main body 12. The vehicle main body 12 of the embodiment has, for example, a symmetrical outer shape in the vehicle front-rear direction, and is configured to be able to travel in both directions along the vehicle front-rear direction.

The vehicle main body 12 has a plurality of wheels 14. In this embodiment, four wheels 14 are provided in one side part of the vehicle main body 12, and another four wheels 14 are provided in the other side part of the vehicle main body 12. Of the four wheels 14 provided in the one side part, two wheels 14 are provided on the vehicle front side and the other two wheels 14 are provided on the vehicle rear side. In FIG. 1, only the four wheels 14 provided in the one side part of the vehicle main body 12 are shown.

A sliding door (not shown) is provided in the one side part of the vehicle main body 12, and this sliding door is configured to be opened to allow an occupant to get in or out from the side part of the vehicle main body 12. A plurality of seats (not shown) is provided inside the vehicle main body 12.

A driving battery 16 as an object-to-be-cooled is provided under a floor panel 15 constituting a part of the vehicle main body 12. The driving battery 16 is provided at a central part of the vehicle main body 12 in the vehicle front-rear direction and electrically connected to a motor (not shown) that drives the vehicle 10. Electricity is supplied from the driving battery 16 to the motor, and the motor is thereby driven to cause the vehicle 10 to travel. A configuration in which one motor is provided on one side in the vehicle front-rear direction may be adopted. A configuration in which an in-wheel motor is provided in each wheel 14 may be adopted.

Here, a first radiator 18 is provided at a vehicle front-side end of the vehicle main body 12, i.e., an end of the vehicle main body 12 on the one side in the vehicle front-rear direction, and a first fan 22 is provided behind the first radiator 18. A second radiator 20 is provided at a vehicle rear-side end of the vehicle main body 12, i.e., an end thereof on the other side in the vehicle front-rear direction, and a second fan 24 is provided in front of the second radiator 20. Further, the vehicle main body 12 is provided with an electronic control unit (ECU) 26 as a controller that controls each of the first fan 22 and the second fan 24.

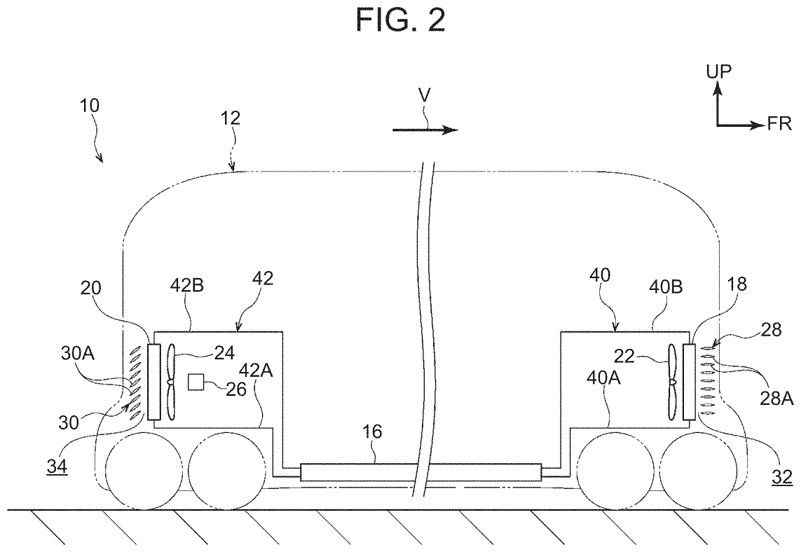

As shown in FIG. 2, the first radiator 18 is provided behind a front-side opening 32 that is formed at a front end of the vehicle main body 12, and is configured such that traveling air is introduced into the first radiator 18 through the front-side opening 32 when the vehicle main body 12 travels forward. Also when the first fan 22 is activated, outside air is introduced into the first radiator 18 from an outside of the vehicle main body 12 through the front-side opening 32.

The first radiator 18 and the driving battery 16 are connected to each other by a first circulation flow passage 40 through which a refrigerant flows. The first circulation flow passage 40 includes a first inflow passage 40A through which the refrigerant having passed through an inside of the driving battery 16 flows into the first radiator 18, and a first outflow passage 40B through which the refrigerant flows out of the first radiator 18.

A pump and a valve (neither is shown) are provided in the first circulation flow passage 40, and the ECU 26 controls the pump and the valve such that the refrigerant circulates through the first circulation flow passage 40 when the driving battery 16 needs to be cooled. As the refrigerant is circulated between the driving battery 16 and the first radiator 18, the refrigerant that has been cooled to a low temperature as a result of heat exchange in the first radiator 18 flows along the driving battery 16. Thus, the vehicle 10 is configured to be able to cool the driving battery 16.

The second radiator 20 is provided in front of a rear-side opening 34 that is formed at a rear end of the vehicle main body 12, and is configured such that traveling air is introduced into the second radiator 20 through the rear-side opening 34 when the vehicle main body 12 travels backward. Also when the second fan 24 is activated, outside air is introduced into the second radiator 20 from the outside of the vehicle main body 12 through the rear-side opening 34.

The second radiator 20 and the driving battery 16 are connected to each other by a second circulation flow passage 42 through which a refrigerant flows. The second circulation flow passage 42 includes a second inflow passage 42A through which the refrigerant having passed through the inside of the driving battery 16 flows into the second radiator 20, and a second outflow passage 42B through which the refrigerant flows out of the second radiator 20. In this embodiment, for example, the first circulation flow passage 40 and the second circulation flow passage 42 are designed to be substantially equal in length.

A pump and a valve (neither is shown) are provided in the second circulation flow passage 42, and the ECU 26 controls the pump and the valve such that the refrigerant is circulated through the second circulation flow passage 42 when the driving battery 16 needs to be cooled. As the refrigerant is circulated between the driving battery 16 and the second radiator 20, the refrigerant that has been cooled to a low temperature as a result of heat exchange in the second radiator 20 flows along the driving battery 16. Thus, the vehicle 10 is configured to be able to cool the driving battery 16.

The front-side opening 32 formed in front of the first radiator 18 is provided with a first shutter 28. The first shutter 28 includes a plurality of rotating blades 28A arrayed in the up-down direction, and is configured to be able to open and close the front-side opening 32 by rotating the rotating blades 28A.

The rear-side opening 34 formed behind the second radiator 20 is provided with a second shutter 30. The second shutter 30 includes a plurality of rotating blades 30A arrayed in the up-down direction, and is configured to be able to open and close the rear-side opening 34 by rotating the rotating blades 30A. The first shutter 28 and the second shutter 30 are electrically connected to the ECU 26 and controlled to open or close through a signal from the ECU 26.

Here, the ECU 26 opens the first shutter 28 and closes the second shutter 30 when the vehicle main body 12 travels forward, i.e., toward the one side in the vehicle front-rear direction. The ECU 26 closes the first shutter 28 and opens the second shutter 30 when the vehicle main body 12 travels backward, i.e., toward the other side in the vehicle front-rear direction.

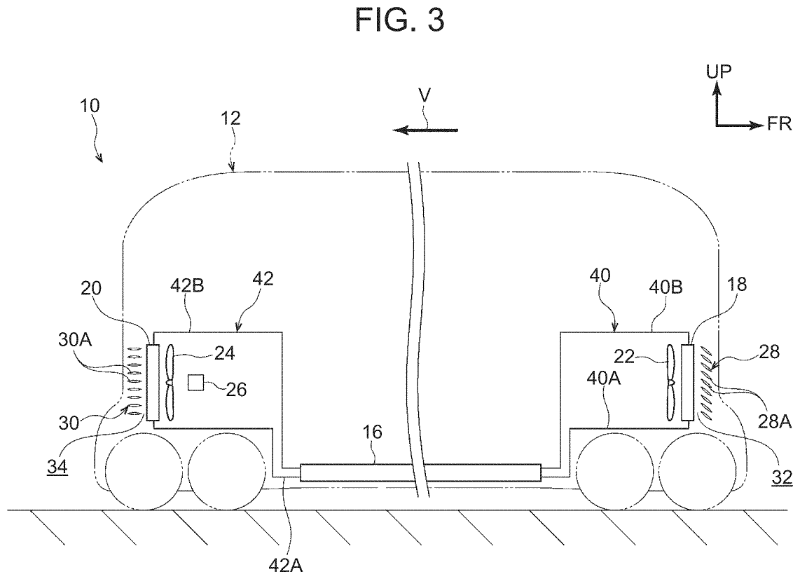

In FIG. 2 and FIG. 3, arrow V indicates a moving direction of the vehicle main body 12. This means that FIG. 2 shows a state where the vehicle main body 12 is moving forward. In this case, the ECU 26 opens the first shutter 28 and closes the second shutter 30, and traveling air 10 is thereby introduced into the first radiator 18 through the front-side opening 32. Meanwhile, no outside air is introduced into the second radiator 20.

FIG. 3 shows a state where the vehicle main body 12 is moving backward. In this case, the ECU 26 closes the first shutter 28 and opens the second shutter 30, and traveling air 10 is thereby introduced into the second radiator 20 through the rear-side opening 34. Meanwhile, no outside air is introduced into the first radiator 18.

### Workings

Next, the workings of this embodiment will be described.

In the vehicle 10 of the embodiment, when the vehicle main body 12 travels in the frontward direction as shown in FIG. 2, heat exchange is performed between traveling air introduced into the first radiator 18 and the refrigerant, so that the driving battery 16 can be cooled with the cooled refrigerant. On the other hand, when the vehicle main body 12 travels toward the other side, heat exchange is performed between traveling air introduced into the second radiator 20 and the refrigerant, so that the driving battery 16 can be cooled with the cooled refrigerant. In this way, the driving battery 16 that is the object-to-be-cooled can be effectively cooled in whichever direction along the vehicle front-rear direction the vehicle 10 travels. Thus, the vehicle 10 structured to be able to travel in both directions along the vehicle front-rear direction can effectively cool the object-to-be-cooled regardless of the traveling direction.

When the vehicle main body 12 of the vehicle 10 of this embodiment travels forward, the ECU 26 closes the second shutter 30, so that an air current having flowed toward the rear side along an outer surface of the vehicle main body 12 can be kept from entering the second radiator 20 through the rear-side opening 34. Similarly, when the vehicle main body 12 travels backward, the ECU 26 closes the first shutter 28, so that an air current having flowed toward the front side along the outer surface of the vehicle main body 12 can be kept from entering the first radiator 18. As a result, the vehicle 10 can deliver enhanced aerodynamic performance while traveling.

In the vehicle 10 of this embodiment, the driving battery 16 is provided at the central part of the vehicle main body 12 in the vehicle front-rear direction. Thus, the distance from the first radiator 18 to the driving battery 16 and the distance from the second radiator 20 to the driving battery 16 are approximately equal. Therefore, the length of the first circulation flow passage 40 on the side of the first radiator 18 and the length of the second circulation flow passage 42 on the side of the second radiator 20 are approximately equal, which can reduce changes in the cooling performance according to the traveling direction of the vehicle main body 12. In other words, variation in the cooling performance can be reduced.

### Second Embodiment

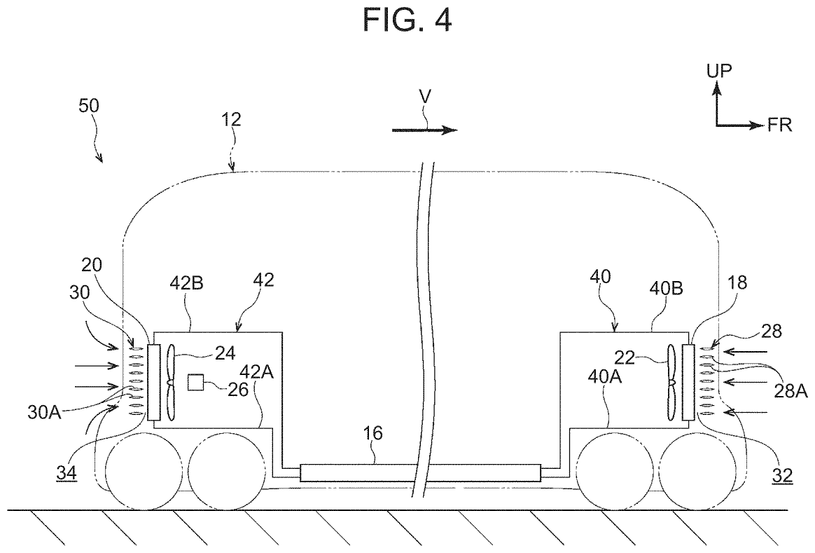

Next, a vehicle 50 according to a second embodiment of the disclosure will be described with reference to FIG. 4. Those components that are the same as in the first embodiment will be denoted by the same reference signs and the description thereof will be omitted as appropriate.

As shown in FIG. 4, the vehicle 50 of this embodiment has the same configuration as the first embodiment, with the only difference being the method of control performed by the ECU 26. The ECU 26 constituting a part of the vehicle 50 of this embodiment does not control opening and closing of the first shutter 28 and the second shutter 30, and these shutters remain open. Thus, the disclosure may be applied to a vehicle that is not provided with the first shutter 28 and the second shutter 30.

The ECU 26 of this embodiment activates the second fan 24 when the vehicle main body 12 travels forward, i.e., toward the one side in the vehicle front-rear direction. The ECU 26 activates the first fan 22 when the vehicle main body 12 travels backward, i.e., toward the other side in the vehicle front-rear direction, although this case is not shown.

### Workings

Next, the workings of this embodiment will be described.

In the vehicle 50 according to this embodiment, when the vehicle main body 12 travels forward, traveling air 50 is introduced into the first radiator 18 through the front-side opening 32 and heat exchange is performed in the first radiator 18. In this case, the ECU 26 activates the second fan 24, so that outside air is introduced into the second radiator 20 through the rear-side opening 34 and heat exchange is performed also in the second radiator 20. Thus, the driving battery 16 can be cooled more efficiently than when the driving battery 16 is cooled with only the refrigerant that has undergone heat exchange in the first radiator 18.

On the other hand, when the vehicle main body 12 travels backward, since the vehicle main body 12 travels in the opposite direction from FIG. 4, traveling air 50 is introduced into the second radiator 20 through the rear-side opening 34 and heat exchange is performed in the second radiator 20. In this case, the ECU 26 activates the first fan 22. As a result, outside air is introduced into the first radiator 18 through the front-side opening 32 and heat exchange is performed also in the first radiator 18. Thus, the driving battery 16 can be cooled more efficiently than when the driving battery 16 is cooled with only the refrigerant that has undergone heat exchange in the second radiator 20. In this way, heat exchange can be performed in both the first radiator 18 and the second radiator 20 in whichever direction the vehicle main body 12 travels, which can enhance the cooling performance of the driving battery 16. The other workings are the same as in the first embodiment.

### Third Embodiment

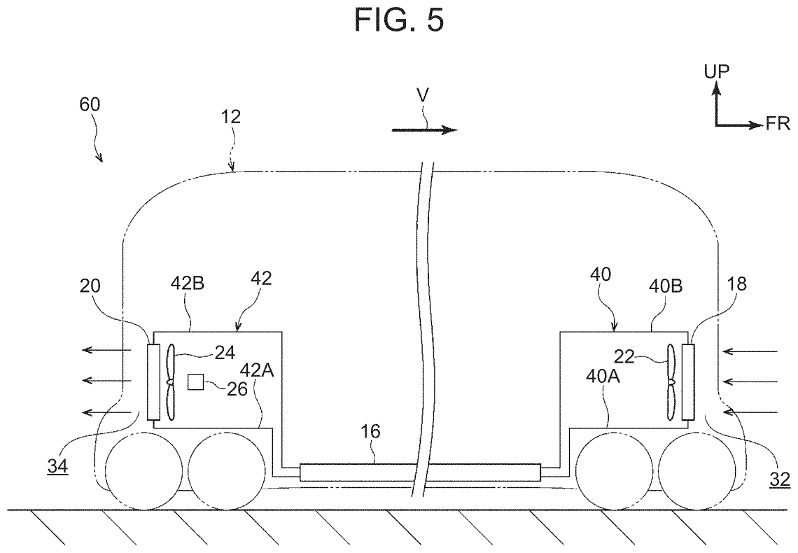

Next, a vehicle 60 according to a third embodiment of the disclosure will be described with reference to FIG. 5. Those components that are the same as in the first embodiment will be denoted by the same reference signs and the description thereof will be omitted as appropriate.

As shown in FIG. 5, the first fan 22 provided in the vehicle main body 12 of the vehicle 60 of this embodiment is capable of turning in both normal and reverse directions, and is configured such that the turning direction can be changed by the ECU 26. For example, when the first fan 22 turns in the normal direction, outside air is introduced into the first radiator 18 through the front-side opening 32. On the other hand, when the first fan 22 turns in the reverse direction, air is exhausted from the first radiator 18 toward the front side, i.e., the outside of the vehicle, through the front-side opening 32.

Like the first fan 22, the second fan 24 is capable of turning in both normal and reverse directions, and is configured such that the turning direction can be changed by the ECU 26. When the second fan 24 turns in the normal direction, outside air is introduced into the second radiator 20 through the rear-side opening 34. On the other hand, when the second fan 24 turns in the reverse direction, air is exhausted from the second radiator 20 toward the rear side, i.e., the outside of the vehicle, through the rear-side opening 34.

Here, the ECU 26 of this embodiment activates the second fan 24 so as to turn in the reverse direction when the vehicle main body 12 travels forward. The ECU 26 activates the first fan 22 so as to turn in the reverse direction when the vehicle main body 12 travels backward.

### Workings

Next, the workings of this embodiment will be described.

In the vehicle 60 according to this embodiment, when the vehicle main body 12 travels forward, the ECU 26 activates the second fan 24 and air is thereby exhausted from the second radiator 20 toward the outside of the vehicle through the rear-side opening 34. Thus, an air current having flowed toward the rear side along the outer surface of the vehicle main body 12 during travel of the vehicle 60 is regulated, and outside air can be kept from entering the second radiator 20.

On the other hand, when the vehicle main body 12 travels backward, the ECU 26 activates the first fan 22 and air is thereby exhausted from the first radiator 18 toward the outside of the vehicle through the front-side opening 32. Thus, an air current having flowed toward the front side along the outer surface of the vehicle main body 12 during travel of the vehicle 60 is regulated, and outside air can be kept from entering the first radiator 18. In this way, the vehicle 60 of this embodiment can deliver enhanced aerodynamic performance despite the configuration thereof not including a shutter.

While the vehicles 10, 50, 60 according to the first to third embodiments have been described above, it should be understood that the disclosure can be implemented in various forms within the scope of the gist of the disclosure. In the above embodiments, the driving battery 16 has been illustrated and described as one example of the object-to-be-cooled. However, the disclosure is not limited to this example, and the vehicle may be configured to cool other object-to-be-cooled. For example, a part that reaches a high temperature, such as a driving motor or an automated driving ECU, may be set as the object-to-be-cooled.

One example of a configuration in which a driving motor is set as the object-to-be-cooled in addition to the driving battery 16 will be described. In the configuration in which a driving motor is provided at a front part of the vehicle main body 12, the first circulation flow passage 40 is configured so as to pass through the driving battery 16 and the motor. When the vehicle main body 12 travels in the frontward direction, heat exchange is performed between traveling air introduced into the first radiator 18 and the refrigerant, so that the driving battery 16 and the motor can be cooled with the cooled refrigerant. In the second embodiment, the vehicle may be configured such that when the vehicle main body 12 travels backward, the ECU 26 activates the first fan 22 to thereby introduce outside air into the first radiator 18 through the front-side opening 32 and cool only the motor. Thus, it is possible to cool the motor with the refrigerant that has undergone heat exchange in the first radiator 18, while cooling the driving battery 16 with the refrigerant that has undergone heat exchange in the second radiator 20 as traveling air is introduced into the second radiator 20 through the rear-side opening 34. In this case, a configuration may be adopted in which valves are provided in the first circulation flow passage 40 and a predetermined valve is opened and closed to allow the refrigerant to flow only to the motor.

In the first embodiment, the first shutter 28 and the second shutter 30 are rotary shutters. However, the disclosure is not limited to this example, and shutters that open and close openings by other method may be used. For example, sliding shutters may be used.

Other than a liquid, such as a coolant, a gas may be used as the refrigerant in the above embodiments.

The vehicles 10, 50, 60 of the above embodiments are electric vehicles having a motor as a driving source, but the disclosure is not limited to this example. The disclosure may also be applied, for example, to a hybrid vehicle having an engine and a motor as driving sources. In this case, the vehicle may be adapted to travel in both directions along the vehicle front-rear direction when traveling only on driving power from the motor with the engine turned off.

What is claimed is:

1. A vehicle comprising:
a vehicle main body capable of traveling in both directions along a vehicle front-rear direction;
a first radiator that is provided at an end of the vehicle main body on one side in the vehicle front-rear direction and performs heat exchange with an object-to-be-cooled provided in the vehicle main body through a refrigerant; and
a second radiator that is provided at an end of the vehicle main body on the other side in the vehicle front-rear direction and performs heat exchange with the object-to-be-cooled through a refrigerant.

2. The vehicle according to claim 1, further comprising:
a first shutter capable of opening and closing an opening through which traveling air is introduced into the first radiator;
a second shutter capable of opening and closing an opening through which traveling air is introduced into the second radiator; and
a controller that opens and closes the first shutter and the second shutter in such a manner that the first shutter is opened and the second shutter is closed when the vehicle main body travels toward one side in the vehicle front-rear direction and that the first shutter is closed and the second shutter is opened when the vehicle main body travels toward the other side in the vehicle front-rear direction.

3. The vehicle according to claim 1, further comprising:
a first fan that is activated to introduce outside air into the first radiator;
a second fan that is activated to introduce outside air into the second radiator; and
a controller that activates the second fan when the vehicle main body travels toward one side in the vehicle front-rear direction, and activates the first fan when the vehicle main body travels toward the other side in the vehicle front-rear direction.

4. The vehicle according to claim 1, further comprising:
a first fan that is activated to exhaust air from the first radiator toward one side in the vehicle front-rear direction;
a second fan that is activated to exhaust air from the second radiator toward the other side in the vehicle front-rear direction; and
a controller that activates the second fan when the vehicle main body travels toward one side in the vehicle front-rear direction, and activates the first fan when the vehicle main body travels toward the other side in the vehicle front-rear direction.

5. The vehicle according to claim 1, wherein the object-to-be-cooled includes a driving battery that is provided at a central part of the vehicle main body in the vehicle front-rear direction.
